(19) United States
(12) Patent Application Publication
(10) Pub. No.: US 2006/0274716 A1
(43) Pub. Date: Dec. 7, 2006

(54) Identifying an endpoint using a subscriber label

(75) Inventors: Anand K. Oswal, Santa Clara, CA (US); Jayaraman R. Iyer, Sunnyvale, CA (US); David P. Lindert, San Jose, CA (US); Naiming Shen, Santa Clara, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/143,412

(22) Filed: Jun. 1, 2005

(51) Int. Cl. H04L 12/66

(52) U.S. Cl. 370/349; 370/352

(57) ABSTRACT

Forwarding a packet includes facilitating a communication session for a mobile node. A packet is identified as received from the mobile node. One or more labels are added to the packet. A subscriber label of the one or more labels uniquely identifies the mobile node for the communication session. The packet is forwarded to a gateway. The gateway is operable to uniquely identify the mobile node from the subscriber label.

### TECHNICAL FIELD

This invention relates generally to the field of communications and more specifically to identifying an endpoint using a subscriber label.

### BACKGROUND

An endpoint may communicate Internet Protocol (IP) packets to another endpoint through a communication network. In general, an endpoint such as a mobile node may communicate packets to a cell site, which in turn sends the packets to a gateway. The gateway typically needs to uniquely identify the endpoint.

Known techniques for uniquely identifying an endpoint involve establishing a Generic Routing Encapsulation (GRE) tunnel between the cell site and the gateway. The gateway may use a GRE key to uniquely identify the endpoint. Establishing a GRE tunnel, however, may not be efficient in certain situations. It is generally desirable to have efficient identification of endpoints.

### SUMMARY OF THE DISCLOSURE

In accordance with the present invention, disadvantages and problems associated with previous techniques for transporting a packet may be reduced or eliminated.

According to one embodiment of the present invention, forwarding a packet includes facilitating a communication session for a mobile node. A packet is identified as received from the mobile node. One or more labels are added to the packet. A subscriber label of the one or more labels uniquely identifies the mobile node for the communication session. The packet is forwarded to a gateway. The gateway is operable to uniquely identify the mobile node from the subscriber label.

Certain embodiments of the invention may provide one or more technical advantages. A technical advantage of one embodiment may be that a subscriber label that identifies an endpoint is added to a packet. The subscriber label may be prepended to the packet, without the need to encapsulate the packet in another packet. Accordingly, use of the subscriber label may reduce the overhead of the packet.

Another technical advantage of one embodiment may be that a transport label may also be added to the packet. The transport label may comprise a Multi-Protocol Label Switching Label (MPLS). Accordingly, the embodiment may have the path optimization and protection features of MPLS features.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a system that transports a packet using one or more multi-protocol labels;

FIG. 2 is a block diagram illustrating a system transporting one embodiment of a packet with a subscriber label; and

FIG. 3 is a block diagram illustrating a system transporting another embodiment of a packet with subscriber and transport labels.

### DETAILED DESCRIPTION OF THE DRAWINGS

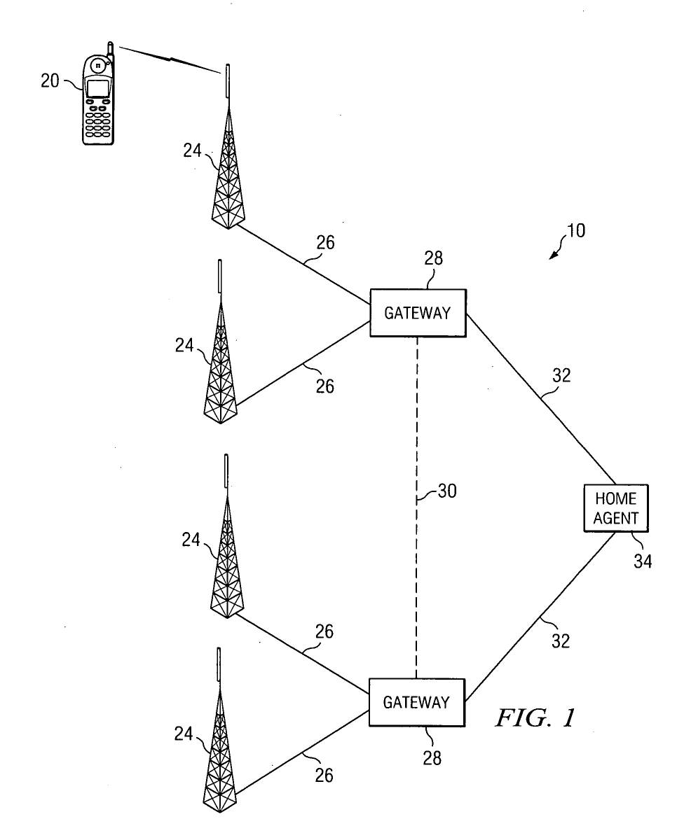

Embodiments of the present invention and its advantages are best understood by referring to FIGS. 1 through 3 of the drawings, like numerals being used for like and corresponding parts of the various drawings.

FIG. 1 is a block diagram illustrating one embodiment of a system that transports a packet using one or more multi-protocol labels. A network device, such as a cell site or packet gateway, of the system may allocate a unique label for an endpoint during a communication session. A gateway may use the label to identify the endpoint during the session. The label may be prepended to the packet, without the need to encapsulate the packet in another packet. Accordingly, use of the label may reduce the overhead of the packet.

According to the illustrated embodiment, system 10 operates to provide services such as communication sessions to endpoints such as a mobile node 20. A communication session may refer to an active communication between endpoints, measured from endpoint to endpoint. An endpoint may refer to an originating or terminating entity, for example, a user, a subscriber, an account, or a device such as mobile node 20.

Information is communicated during a communication session. Information may refer to voice, data, text, audio, video, multimedia, control, signaling, other information, or any combination of the preceding. Information may be communicated in packets. A packet may comprise a bundle of data organized in a specific way for transmission, and a frame may comprise the payload of one or more packets organized in a specific way for transmission. A packet-based communication protocol such as Internet Protocol (IP) may be used to communicate the packets.

System 10 may comprise a portion of a communication network that allows devices such as mobile node 20 to communicate with other devices. A communication network may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

System 10 may utilize communication protocols and technologies to provide the communication sessions. Example communication protocols and technologies include those set by the Institute of Electrical and Electronics Engineers, Inc. (IEEE) 802.xx standards such as the 802.11 and 802.16 standards, International Telecommunications Union (ITU-T) standards, European Telecommunications Standards Institute (ETSI) standards, Internet Engineering Task Force (IETF) standards, or other standards.

According to one embodiment, system 10 may operate according to the Multi-Protocol Label Switching (MPLS) IETF standard described in the IETF Request for Comment (RFC) 2702. According to the embodiment, system 10 includes label switched routers. A label switched router may refer to a router that adds a label to a packet, forwards a packet or performs any other suitable operation on a packet based upon its label, removes a label from a packet, or any suitable combination of the preceding. A label may refer to a set of symbols used to identify an item. Example labels are discussed below. A label may be attached to a packet in any suitable manner, for example, the label may be prepended to the packet header preceding the packet payload.

Label switched routers include edge label switched routers and intermediate label switched routers. An edge label switched router adds or removes a label from a packet. Edge label switched routers include ingress label switched routers and egress label switched routers. An ingress label switched router classifies a packet, and attaches a label to the packet based upon the classification. An ingress label switched router may also calculate label switched path for the packet and instantiate the label switched path. A label switched path may refer to a path that routes packets according to the labels of the packets. An intermediate label switched router processes labeled packets based on the labels. For example, an intermediate label switched may forward traffic based on the labels. An egress label switched router removes the label from a packet, and may operate on the packet.

According to the illustrated embodiment, system 10 includes one or more mobile nodes 20, one or more cell sites 24, one or more reference points 26, one or more gateways 28, and a home agent 34 coupled as shown. Mobile node 20 represents any suitable device operable to communicate with a communication system. In general, a device may include any suitable arrangement of components operable to perform the operations of the device. Mobile node 20 may comprise, for example, a personal digital assistant, a computer such as a laptop, a cellular telephone, a mobile handset, or any other device operable to communicate with system 10.

Cell site 24 represents an access point that provides wireless services to mobile node 20 present in, or visiting, a cell. A cell may refer to a geographic unit of a network attachment point of a communication network. As an example, a cell may refer to represent a cell of a cellular network or a hot spot of a wireless network. A mobile node 20 may be present in, or visiting, a cell if mobile node 20 is within the range of cell site 24 of the cell. An access point may refer to a network point that couples a wireless network, such as a wireless radio network, to a wired network, such as a wired area network.

A cell site 24 may comprise any suitable logic operable to provide wireless services to mobile nodes 20 present in a cell. According to one embodiment, cell site 24 includes a base transceiver station and a base station controller. The base transceiver station communicates signals to and from mobile node 20 through a wireless link that is typically a radio frequency link. The base station controller manages the operation of the base transceiver station.

According to one embodiment, cell site 24 operates as an ingress label switched router. As a packet enters network 10 through cell site 24, cell site 24 classifies the packet and selects a label in accordance with the classification. The classification may be based on any suitable information in the packet, for example, a source address, a destination address, a source port, a destination port, or an equivalence class. According to one embodiment, the packet is classified based on the endpoint sending the packet, which may be identified by the source address of the packet. A subscriber label that uniquely identifies the endpoint may be selected. According to one embodiment, an endpoint may be engaged in multiple sessions. In this embodiment, a different subscriber label may be allocated for each session.

According to another embodiment, cell site 24 may select a label in accordance with a label switched path calculated for the packet. Intermediate routers along the path may be identified, and a transport label that may be used by the intermediate routers to transport the packet may be selected. The transport label may be learned from a protocol such as a Resource ReserVation Protocol (RSVP) or a Label Distribution Protocol (LDP). A label may include any suitable information, for example, the type of information in the payload or the grade of service of the data stream.

Packets, however, may be classified in any other suitable manner. For example, the classification may be based on a forwarding equivalence class. A forwarding equivalence class may refer to a group of packets or a data stream that require the same handling, for example, class of service. The first packet of the data stream may be labeled according to the classification of the first packet, and subsequent packets may be automatically labeled.

According to one embodiment, the one or more labels attached by cell site 24 may comprise one or more multi-protocol label switching (MPLS) labels. An MPLS label typically comprises twenty bits of an MPLS header, which comprises four or eight octets. An MPLS label may comprise a twenty bit field, and an MPLS header may have forty bytes. A label may also be reduced using header compression. As an example, an MPLS label may be reduced using MPLS header compression.

A label may comprise any suitable fields, for example, a label value field, a class of service field, a bottom of stack field, a time-to-live field, or any suitable combination of the preceding. A label value field may include an endpoint identifier that uniquely identifies an endpoint, a transport value that allows an intermediate router to switch a packet, or both. A class of service field may be used to indicate the class of service for the packet. A bottom of stack field may be used to indicate whether a label is the last label of the stack. A time-to-live field is used to indicate whether the packet is at the egress router. Labels may be placed between the Layer 2 link information and the encapsulated packet or may be encoded in the link-layer information.

Cell site 24 sends the labeled packet to other nodes of system 10. The other nodes may then read the one or more labels and switch the packet according to the labels. The label is typically smaller than the header of the packet, so the other nodes may switch the packet with greater speed.

Reference point 26 represents a reference point that enables the delivery of messages between cell site 24 and gateway 28.

Gateway 28 represents an access service network (ASN) gateway, and may authenticate mobile node 20. Gateway 28 typically needs to uniquely identify endpoints to authenticate them. In certain situations, the IP address may not be a unique identifier. As an example, private networks may assign the same IP address to different endpoints. According to one embodiment, gateway 28 operates as an egress label switched router. Gateway 28 receives a packet, reads the subscriber label of the packet, and identifies the endpoint according to the label. Gateway 28 may provide other suitable operations. For example, gateway 28 may convert communications between different communication protocols.

Reference point 30 represents a reference point that enables the delivery of messages between packet gateways. Home agent 34 represents any suitable device operable to maintain the address of mobile node 20 and forward data to mobile node 20. A foreign agent of mobile node 20 may refer to an agent that provides home agent 34 of mobile node 20 with an address to which data for mobile node 20 may be forwarded. Reference point 32 represents a reference point that enables the delivery of messages between a packet gateway and a home agent.

System 10 may include other suitable components operable to facilitate communications sessions. As an example, system 10 may include an authorization server. An authorization server may represent any suitable device operable to provide authorization-related services. Authorization-related services may include services for authentication, authorization, accounting, or any suitable combination of the preceding. Authentication may refer to validating the identity of mobile node 20. Authorization may refer to authorizing a level of service for mobile node 20. Accounting may refer to tracking the usage of resources. As an example, an authorization server may provide one, two, or three of the listed services.

A component of system 10 may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations. “Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to system 10 without departing from the scope of the invention. The components of system 10 may be integrated or separated according to particular needs. Moreover, the operations of system 10 may be performed by more, fewer, or other modules. Additionally, operations of system 10 may be performed using any suitable logic. As used in this document, “each” refers to each member of a set or each member of a subset of a set.

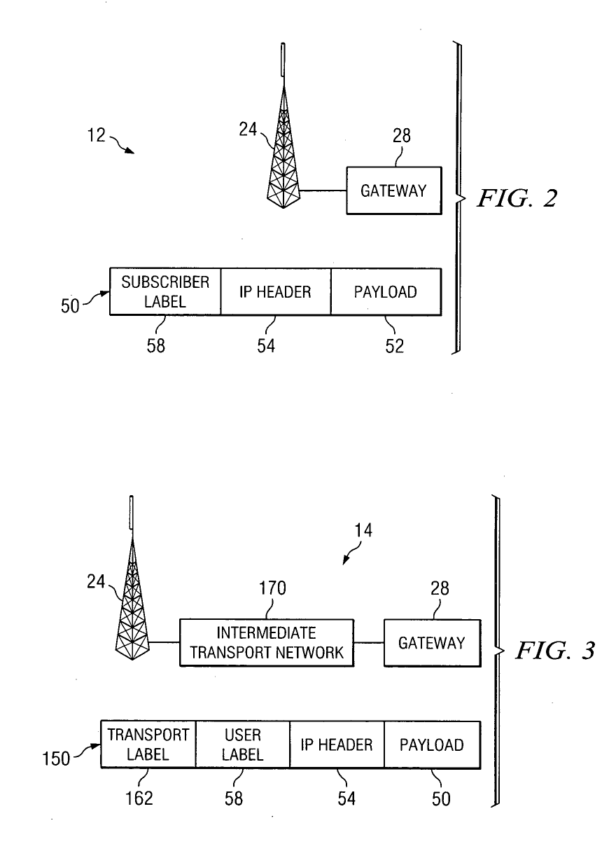

FIG. 2 is a block diagram illustrating a system 12 transporting one embodiment of a packet 50 with a subscriber label. According to the illustrated embodiment, system 12 includes cell site 24 and gateway 28. Cell site 24 and gateway 28 may be substantially similar to those of system 10 of FIG. 1.

As packet 50 enters cell site 24, packet includes a payload 52 and an IP header 54. IP header 54 may include IP control information that guides packet 50 to its destination. Payload 52 may represent the portion of packet 50 that communicates information to and from mobile node 20, and may be differentiated from system overhead information. Payload 52 may also include other information, such as user-requested network management and accounting information.

Cell site 24 classifies packet 50 and selects a label in accordance with the classification. According to one embodiment, cell site 24 classifies packet 50 according to the source address in IP header 54, and selects subscriber label 58 to uniquely identify the endpoint identified by the source address.

Gateway 28 receives packet 50 with subscriber label 58, and routes the packet according to information in subscriber label 58. Gateway 28 also identifies the endpoint associated with packet 50. Gateway 28 may remove subscriber label 58 from packet before sending packet 20 to home agent 34.

Gateway 28 may also attach a similar subscriber label 58 to packets 50 traveling from gateway 28 to cell site 24. According to one embodiment, a packet 50 from cell site 24 to gateway 28 may have a different subscriber label 58 than that of a packet from gateway 28 to cell site 24.

Packet 50 with subscriber label 58 may have a smaller overhead than a packet that is tunneled between cell site 24 and gateway 28. As an example, a packet may be tunneled between cell site 24 and gateway 28 through a generic routing encapsulation (GRE) tunnel. The tunnel packet typically includes a payload, an IP header, a GRE header, and another IP header. The GRE header and the additional IP header is typically 28 bytes. In comparison, packet 50 uses a smaller subscriber label 58.

Modifications, additions, or omissions may be made to packet 50 without departing from the scope of the invention. Packet 50 may include more, fewer, or other parts arranged in any suitable order.

FIG. 3 is a block diagram illustrating a system 14 transporting another embodiment of a packet 150 with subscriber and transport labels. According to the illustrated embodiment, system 14 includes a cell site 24, an intermediate transport network 170, and gateway 28. Cell site 24 and gateway 28 may be substantially similar to those of system 10 of FIG. 1. Intermediate transport node 170 may comprise an intermediate label switched router.

Packet 150 includes a payload 52, an IP header 54, a subscriber label 58, and a transport label 162. Payload 52, IP header 54, and subscriber label 58 may be substantially similar to those of FIG. 2.

Cell site 24 classifies packet 150 and selects one or more labels in accordance with the classification. According to one embodiment, cell site 24 classifies packet 150 according to the source address in the IP header 54, and selects subscriber label 58 to uniquely identify the endpoint identified by the source address.

Transport label 162 may be used to transport packet 150 from cell site 24 to gateway 28. Transport label 162 may allow intermediate transport node 170 to route packet 150 to gateway 28, and may be conform to a transport protocol recognized by intermediate transport node 170. As an example, transport label 162 may be written according to a Resource ReserVation Protocol (RSVP), a Label Distribution Protocol (LDP), or other protocol. Transport label 162 may be learned from a protocol, for example, RSVP.

Intermediate transport network 170 includes one or more intermediate transport nodes. An intermediate transport node comprises an intermediate label switched router operable to route packet 150 according to transport label 162. An intermediate transport node may change transport label 162 to another transport label 162 in order to change a label switched path. A label switched path may be changed to increase packet transport speed, to avoid a faulty path node, or for any other suitable reason. Gateway 28 receives packet 150 with subscriber label 58 and transport label 162. The gateway may remove transport label 162 and may identify the endpoint from subscriber label 158. Gateway 28 may remove subscriber label 158 from packet before sending packet 20 to home agent 34.

Gateway 28 may also attach a similar subscriber label 158 and transport label 162 to packets 150 traveling from gateway 28 to cell site 24. According to one embodiment, a packet 150 from cell site 24 to gateway 28 may have different labels than those of a packet from gateway 28 to cell site 24.

Modifications, additions, or omissions may be made to packet 150 without departing from the scope of the invention. Packet 150 may include more, fewer, or other parts arranged in any suitable order.

Certain embodiments of the invention may provide one or more technical advantages. A technical advantage of one embodiment may be that a label that identifies an endpoint is added to a packet. The label may be prepended to the packet, without the need to encapsulate the packet in another packet. Accordingly, use of the label may reduce the overhead of the packet.

Another technical advantage of one embodiment may be that a transport label may also be added to the packet. The transport label may comprise a Multi-Protocol Label Switching Label (MPLS). Accordingly, the embodiment may have the path optimization and protection features of MPLS features.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for forwarding a packet, comprising:
facilitating a communication session for a mobile node;
receiving a packet from the mobile node;
classifying the packet as from the mobile node during the communication session;
adding one or more labels to the packet, a subscriber label of the one or more labels uniquely identifying the mobile node for the communication session; and
forwarding the packet to a gateway, the gateway operable to uniquely identify the mobile node from the subscriber label.

2. The method of claim 1, wherein:
facilitating the communication session for the mobile node further comprises:
facilitating the communication session through one or more intermediate transport nodes to the gateway; and
adding the one or more labels to the packet further comprises:
attaching the subscriber label to the packet; and
attaching a transport label to the packet, an intermediate transport node of the one or more intermediate transport nodes operable to forward the packet to the gateway in accordance with the transport label.

3. The method of claim 1, wherein:
the one or more labels comprises one or more multi-protocol label switching (MPLS) labels.

4. A network device for forwarding a packet, comprising:
an interface operable to:
receive a packet from a mobile node in a communication session; and
a processor in communication with the interface and operable to:
classify the packet as from the mobile node during the communication session;
add one or more labels to the packet, a subscriber label of the one or more labels uniquely identifying the mobile node for the communication session; and
forward the packet to a gateway, the gateway operable to uniquely identify the mobile node from the subscriber label.

5. The network device of claim 4, wherein the processor is further operable to:
facilitate the communication session for the mobile node by:
facilitating the communication session through one or more intermediate transport nodes to the gateway; and
add the one or more labels to the packet by:
attaching the subscriber label to the packet; and
attaching a transport label to the packet, an intermediate transport node of the one or more intermediate transport nodes operable to forward the packet to the gateway in accordance with the transport label.

6. The network device of claim 4, wherein:
the one or more labels comprises one or more multi-protocol label switching (MPLS) labels.

7. The network device of claim 4, wherein:
the processor is further operable to:
facilitate the communication session for the mobile node by:
facilitating the communication session through one or more intermediate transport nodes to the gateway; and
add the one or more labels to the packet by:
attaching the subscriber label to the packet; and
attaching a transport label to the packet, an intermediate transport node of the one or more intermediate transport nodes operable to forward the packet to the gateway in accordance with the transport label; and
the one or more labels comprises one or more multi-protocol label switching (MPLS) labels.

8. A system for forwarding a packet, comprising:
means for facilitating a communication session for a mobile node;
means for receiving a packet from the mobile node;
means for classifying the packet as from the mobile node during the communication session;
means for adding one or more labels to the packet, a subscriber label of the one or more labels uniquely identifying the mobile node for the communication session; and
means for forwarding the packet to a gateway, the gateway operable to uniquely identify the mobile node from the subscriber label.

9. A method for identifying an endpoint, comprising:
facilitating a communication session for a mobile node in a communication network comprising a cell site;
receiving a packet from the cell site, the packet comprising a subscriber label, the subscriber label uniquely identifying the mobile node for the communication session, the subscriber label comprising multi-protocol label switching (MPLS) label; and
identifying the mobile node from the subscriber label.

10. The method of claim 9, further comprising:
authorizing the identified mobile node for a service.

11. A network device operable to identify an endpoint, comprising:
an interface operable to:
receive a packet from a cell site of a communication network, the packet comprising a subscriber label, the subscriber label uniquely identifying a mobile node for a communication session, the subscriber label comprising multi-protocol label switching (MPLS) label; and
a processor in communication with the interface and operable to:
facilitate the communication session for the mobile node; and
identify the mobile node from the subscriber label.

12. The network device of claim 11, the processor further operable to:
authorize the identified mobile node for a service.

13. A network system for forwarding a packet, comprising:
a cell site operable to:
receive a packet from a mobile node in a communication session;
classify the packet as from the mobile node during the communication session; and
add one or more labels to the packet, a subscriber label of the one or more labels uniquely identifying the mobile node for the communication session; and
a gateway operable to:
receive the packet from the cell site; and
identify the mobile node from the subscriber label.

14. The network system of claim 13, wherein:
the cell site is further operable to:
add the one or more labels to the packet by:
attaching the subscriber label to the packet; and
attaching a transport label to the packet; and
the network system further comprising one or more intermediate transport nodes, an intermediate transport node operable to:
forward the packet to the gateway in accordance with a current transport label; remove the current transport label; and attach a next transport label.

15. The network system of claim 13, wherein:
the one or more labels comprises one or more multi-protocol label switching (MPLS) labels.

16. The network system of claim 13, the gateway further operable to:
authorize the identified mobile node for a service in accordance with the subscriber label.

17. The network system of claim 13, the gateway further operable to:
authenticate the identified mobile node in accordance with the subscriber label.

18. The network system of claim 13, the gateway further operable to:
remove the one or more labels.

19. A data structure embodied in a medium, the data structure comprising a message for identifying a mobile node, the message communicated from a cell site to a gateway and comprising:
a payload comprising information to be communicated during a communication session for a mobile node;
an Internet Protocol (IP) header comprising routing information for routing the data packet; and
one or more multi-protocol label switching (MPLS) labels comprising:
a subscriber label uniquely identifying the mobile node, the gateway operable to identify the mobile node from the subscriber label.

20. The data structure of claim 19, wherein:
the one or more multi-protocol label switching (MPLS) labels further comprise:
a transport label, an intermediate transport node of one or more intermediate transport nodes between the cell site and the gateway operable to route the data packet according to the transport label.
